(19) United States
(12) Patent Application Publication
(10) Pub. No.: US 2026/0246493 A1
(43) Pub. Date: Aug. 20, 2026

(54) METHOD FOR TESTING AN INDUCTIVE COMMUNICATION LINK AND TESTING TOOL

(71) Applicant: Endress+Hauser Conducta GmbH+Co. KG, Gerlingen (DE)

(72) Inventor: Robert Tzschoppe, Großweitzschen (DE)

(21) Appl. No.: 19/543,383

(22) Filed: Feb. 18, 2026

(30) Foreign Application Priority Data
Feb. 19, 2025 (DE) 10 2025 106 176.9

(51) Int. Cl. H04B 3/46; H04B 5/24; H04B 5/73

(52) U.S. Cl. CPC H04B 3/46; H04B 5/24; H04B 5/73

(57) ABSTRACT

A method for testing an inductive communication link between a cable and a sensor linkable thereto, comprising: mechanically and electrically linking a device with the cable; measuring at least one electrical parameter during communication or in a communication pause between the device and the cable; registering at least one communication parameter during communication between the device and the cable; creating communication statistics; and persistently storing all measured values.

### CROSS-REFERENCE TO RELATED APPLICATION

The present application is related to and claims the priority benefit of foreign patent application No 10 2025 106 176.9 filed on Feb. 19, 2025, the entire contents of which are incorporated herein by reference.

### TECHNICAL FIELD

The present disclosure relates to a method for testing an inductive communication link between a sensor and a cable. The present disclosure relates further to a testing tool for performing the method.

### BACKGROUND

Sensors are connected with a measurement transmitter via a cable. The sensor can, in such case, be inductively linked with the cable. The applicant sells such products under the name “Memosens”, for example, the digital pH sensor “Memosens CPS11E”.

The linkage is based on an inductive coupling of two electronic parts. The quality of this coupling depends on various mechanical and electrical parameters as well as environmental conditions. Also, the aging of material and components has an influence. Additionally, a cable can lose quality after a certain lifetime and lead in use to failure of the measuring point. A frequent cause for this is insufficient coupling between cable and sensor. In this way, the sensor possibly receives insufficient power or the communication between sensor and cable is unstable.

Currently, it is not possible to detect the quality of the coupling in the field. It is attempted to find the cause by exchanging sensors and cables. Sometimes cables are replaced for safety sake, because the cause is unknown.

However, no qualified information concerning the error source can be produced. Cables are thrown away, even though the error might be caused by sensors or software. In this way, there arise costs, additional effort and waste at customer plants from the unnecessary replacing of cables.

### SUMMARY

An object of the present disclosure is to evaluate an inductive coupling between a sensor and a cable and to identify sources of error.

The object is achieved by a method for testing an inductive communication link between a cable and a sensor linkable thereto, comprising steps as follows: Mechanical and electrical linking of a device with the cable; measuring at least one electrical parameter during communication or in a communication pause between the device and the cable; registering at least one communication parameter during communication between the device and the cable; creating a communication statistics, especially with identifying direction of a disturbance between the device and the cable; and persistent storing of all measured values.

In normal operation, a cable is linked inductively with a sensor. Consequently, it is basically this linkage that should be tested.

In a first embodiment, instead of the sensor, a testing tool is linked. The above mentioned “device” corresponds, in such case, to the testing tool. The measured values are stored persistently in the testing tool. In such case, mainly the cable and the interface on the cable side can be tested.

In a second embodiment, mainly the sensor and its interface are tested. Here the sensor corresponds to the “device”. Arranged on the cable side is a data processing unit, which measures, or registers, electrical parameters and/or communication parameters. In at least one embodiment, the measured values are stored in a superordinated unit connected to the cable (in the sensor opposite direction). Alternatively, the measured values are stored in a testing tool linked to the cable (the sensor is removed beforehand; the values are, in given cases, stored intermittently in the superordinated unit).

In at least one embodiment, the method is initiated by a superordinated unit, for example, a measurement transmitter.

The two types of testing are not mutually exclusive, and, in at least one embodiment, are done one after another.

At least one embodiment provides that the at least one electrical parameter is the transferred voltage, the transferred electrical current, the inductance(s), the capacitance(s), the impedance(s), the frequency, the phase between voltage and electrical current, the level of the modulated signal during the communication and/or the total harmonic distortion.

In the following, the electrical parameters will be briefly explored:

Transferred voltage: The voltage inductively transferred by the cable to the sensor is decisive, in order to assure that the sensor is supplied with sufficient energy.

Transferred electrical current: The electrical current flowing through the inductive coupling can provide information concerning efficiency of the energy transfer.

Transferred power: Product of electrical current and voltage measured, for example, in a communication pause.

Inductance: The inductance of the coupling influences the efficiency of the energy transfer and is tested, in order to assure that the coupling is functioning optimally.

Capacitance: The capacitance between the coupling elements can influence the transfer characteristics and should likewise be measured.

Impedance: The impedance of the linkage is a measure for the total resistance to the alternating electrical current and can indicate possible losses or disturbances in the transfer.

Signal-noise ratio (SNR): a good signal-noise ratio is important, in order to assure that the signal is received clearly and without disturbances.

Frequency: The frequency of the inductive transfer is tested, in order to assure that it lies in the optimum range.

Phase: The phase between voltage and electrical current can provide information concerning efficiency of the energy transfer.

Total harmonic distortion (HRD): HRD measures the distortion of a signal by harmonic frequencies and can influence the quality of the transfer

One or more of these parameters helps to evaluate the performance and integrity of the inductive transfer and to assure that it corresponds to requirements.

At least one embodiment provides that the at least one communication parameter is the baud rate, the bit times, the character delay time, the frame time-out, the response time, the error rate, the signal-noise ratio, the latency, the jitter, the throughput, the pause between two telegrams and/or the packet loss.

In the following, these communication parameters will be briefly explored:

The baud rate is measured by counting the number of signal changes per second. Such can occur by analysis of the data flow and identification of the signal transitions.

The bit times are measured by registering the length of time of a single bit in the data stream. Such can occur using an oscilloscope or a special bit time measuring device.

The character delay time is the maximum time delay between two sequentially following reference characters in a data stream.

The frame time-out is the maximum time required for sending a complete data frame.

The response time is the time, which a device requires, in order to respond to a received telegram.

The error rate is measured by counting the number of faulty bits or packets per transfer unit. Such can occur by analyzing the data flow and identifying errors.

The signal-noise ratio (SNR) is measured by determining the ratio of the signal strength to the background noise. Such can occur by analyzing the amplitude of the signal compared with the noise.

The latency is measured by registering the delay between the transferring and receiving of a signal.

Jitter is measured by registering the variability of the latency in a network. Such can occur by analyzing the temporal fluctuations in the data stream.

Throughput is the volume of data successfully transferred in a certain time span.

Packet loss is the percentage of data packets lost during transfer.

At least one embodiment provides that the measuring of electrical parameters occurs continuously, in order to provide real time data for analyzing the linkage.

At least one embodiment provides that registered baud rate and bit times are used to optimize synchronization of data transfer.

At least one embodiment provides that communication statistics are used, in order to detect patterns and anomalies in the data transfer.

At least one embodiment provides that measuring electrical parameters occurs at different frequencies, in order to analyze frequency dependence of the linkage.

At least one embodiment provides that measuring electrical parameters occurs under different load conditions, in order to test loadability of the linkage.

The object is further achieved by a testing tool, comprising an inductive interface for linking to a complementarily embodied inductive interface of a cable; a measurement module, which is embodied to measure electrical parameters; a registration module, which is embodied to register communication parameters; a data processing unit for performing the method as above described, wherein the data processing unit is embodied to analyze the registered values and to generate communication statistics; and a persistent memory.

In at least one embodiment, a master-slave architecture is used between the testing tool and the cable, wherein the testing tool corresponds to the slave side.

One or more communication parameters, for example, measuring the response time or latency or measuring at different frequencies, trigger the initiating of the master. In such case, this occurs from the cable or from the measurement transmitter connected thereto. In given cases, measured values are then transferred from the cable or measurement transmitter to a testing tool linked to the cable.

The advantages will now be summarized:

A device of the present disclosure can be quickly sent to a customer and evaluated upon return receipt. In this way, long wait times at the customer are avoided and the customer can with little effort exclude a fault in the cable.

The device can be brought along by service technicians, who can evaluate quality on-site.

It can serve a customer for regularly qualifying its measuring point and so avoid unexpected downtimes.

By these measures, it can be prevented that cables are unnecessarily changed or discarded for safety sake. This reduces waste and saves a customer money.

This tool can be applied at all locations with cable manufacture, in order to assure quality of the manufactured cable.

### BRIEF DESCRIPTION OF THE DRAWINGS

The present disclosure will now be explained in greater detail based on the appended drawing, the figures of which show as follows:

FIG. 1 shows an overview;

FIG. 2 shows an application of the testing tool;

FIG. 3 shows an application of the testing tool;

FIG. 4 shows an application of the testing tool; and

FIG. 5 shows an example of a circuit for performing the method.

### DETAILED DESCRIPTION

In the figures, equal features are provided with equal reference characters.

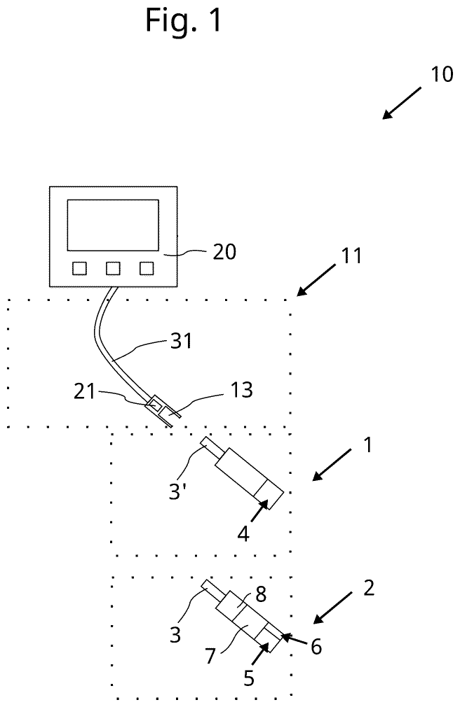

A sensor arrangement 10 includes a sensor 1 and a cable 11. FIG. 1 shows sensor arrangement 10. Sensor 1 communicates via an interface 3′ via the cable 11 (with the interface 13) with a superordinated unit 20, here, for example, in the form of a measurement transmitter. Measurement transmitter 20 is connected, in turn, with a control system (not shown). Measurement transmitter 20 is connected sensor side to the cable 11, whose other end comprises the interface 13 complementary to the first interface 3′.

Cable 11 comprises the line 31 and the interface 13. The interfaces 3′, 13 are galvanically separated and embodied here especially as inductive interfaces, which can be coupled with one another by means of a mechanically plugged connection. The mechanically plugged connection is hermetically sealed, such that no external liquid, for instance, the medium to be measured, air or dust can get in. Via the inductive interfaces 3′, 13, there occurs, thus, a mechanical and electrical linkage between cable 11 and sensor 1. Cable 11 can include a data processing unit 21; see below. Data processing unit 21 can also act as a repeater for the communication.

Via the interfaces 3′, 13, data are sent bidirectionally and energy unidirectionally, i.e., in the latter case, from the measurement transmitter 20 to the sensor 1. Sensor arrangement 10 is applied predominantly in process automation. Other applications are possible, for example, in a laboratory environment or in bodies of water. Sensor 1 includes at least one sensor element 4 (shown schematically in FIG. 1) for registering a measured variable of process automation. Sensor 1 is, for example, a pH sensor, e.g., an ion sensitive field effect transistor, in general, an ion-selective sensor, a sensor for measuring redox potential, absorption of electromagnetic waves in the medium, for example, having wavelengths in the UV, IR, and/or visible region, oxygen, conductivity, turbidity, concentration of non-metallic materials or temperature, in each case, in terms of the corresponding measured variable.

For qualifying the inductive linkage between a sensor 1 and cable 11, a testing tool 2 is plugged into the cable 11 to be tested, in place of the sensor 1. Tool 2 measures electrical parameters as well as communication parameters. Such are evaluated by the tool 2 and persistently stored. The parameters can also be read-out at another point in time and location and evaluated with suitable software. Tool 2 is shown in the lower part of FIG. 1. Tool 2 is also referred to as testing tool 2, testing device 2 or simply “device 2”.

Testing tool 2 includes an inductive interface 3 for linking to a complementarily embodied inductive interface 13 of the cable 11. Tool 2 includes, additionally, a measurement module 7, which is embodied to measure electrical parameters, and a registration module 8, which is embodied to register communication parameters, as well as a data processing unit 5, which is embodied to perform the method of the present disclosure. The data processing unit 5 can thus analyze the registered values and generate a communication statistics. Tool 2 includes, additionally, a persistent memory 6.

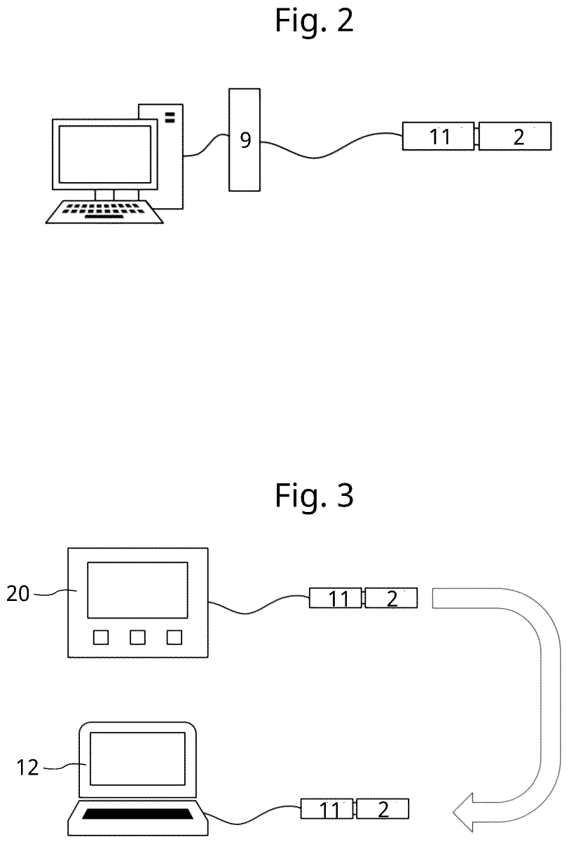

FIG. 2 shows application of the testing tool 2 in development activities. A developer can instruct such device 2 through the cable 11 by means of a control device 9 and move through different test-scenarios, here controlled, for example, by a computer.

In development activities, it is tested whether a cable 11 to be developed meets the requirements. Influences include selected circuit topologies, components, geometries and behavior of software.

Another application lies in the manufacture. In the manufacture, it is tested whether the manufactured cable 11 lies within predetermined tolerances. These fluctuate because of value tolerances of electrical components, geometric tolerances of mechanical components as well as manufacturing tolerances, such as the position of the primary winding or properties of molded insulation.

In service activities, it is tested whether reliable operation can still be assured. This can because of aging of electrical components or mechanical wear from environmental influences, in given cases, no longer be the case.

FIG. 3 shows the application in service activities at the customer in the process. A service technician on-site connects a device 2 to the measurement transmitter 20 via a cable 11. The measurement transmitter 20 attempts to communicate with the device 2. Device 2 does not answer as a sensor would, but, rather, measures the required parameters for the transmission via the interfaces 3, 13 and stores such persistently. The service technician terminates this attempted communication after a short time and then reads collected data with a suitable reading apparatus 12. Then, the parameters are evaluated and the cable 11 qualified, or not, depending on the outcome of the evaluation. The measurement transmitter 20 does not have, for example, programming suitable for the evaluation. It functions passively.

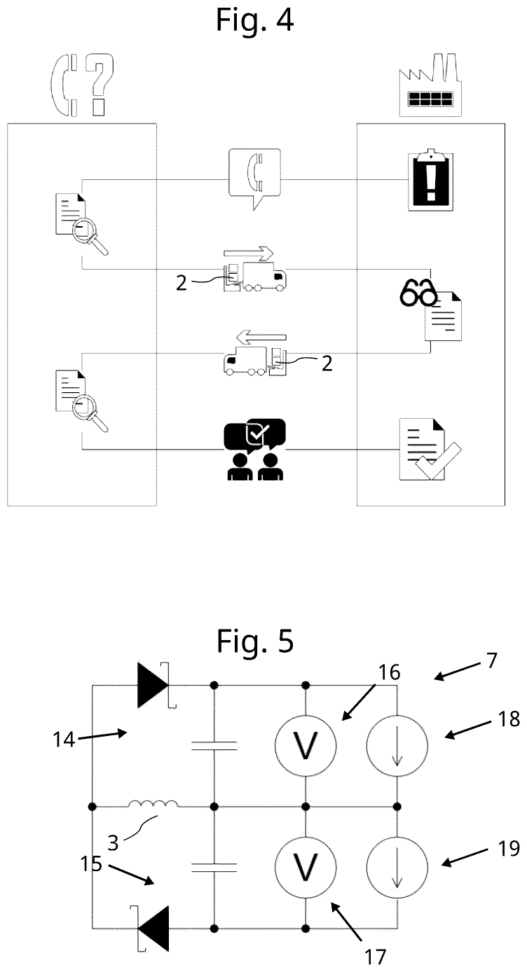

FIG. 4 shows application at the customer (right in FIG. 4) in the process with external evaluation. A customer reports to the service department of the manufacturer (left in FIG. 4) that a problem has arisen. Service sends a device 2 to the customer. The customer plugs such for a short length of time into the cable 11 to be tested. Testing tool 2 measures automatically all needed parameters. Then, the device 2 is sent back and the ascertained parameters evaluated. Thereafter, the customer is advised of a solution for the problem. The customer needs no knowledge concerning the verification.

Another application occurs at the customer in the process with its own evaluation. The device 2 is in possession of the customer. The customer can regularly plug device 2 into a cable 11 and initialize the test, for example, using the measurement transmitter 20. The measurement transmitter 20 together with the device 2 evaluate the state of the cable 11 and document such. Thus, the state of the linkage between measurement transmitter 20 and sensor 1 can be regularly tested.

FIG. 5 shows a symbolic circuit for the testing tool 2.

The induced alternating voltage of the secondary voltage at the inductive interface 3 is rectified by means of one-direction rectifiers 14, 15 for positive and negative half oscillations. In such case, positive and negative voltages result. The values of the voltages are ascertained by means of voltage measurements 16, 17. By defined electrical currents (electrical current measurements 18, 19), the transferred power can be ascertained. This corresponds to the measurement module 7. The ascertaining of the power occurs, for example, via the data processing unit 5, for example, in a communication pause. The data processing unit 5 can be embodied as registration module 8, in order to ascertain the communication parameters. Alternatively, the registration module can be separately embodied.

By changing the load, a transfer—or coupling factor can be ascertained. The ratio of the individual voltages is connected with the coupling. At low coupling, also the voltages are low.

The transfer between sensor 1 and cable 11 can also be tested without testing tool 2. At least in such case, the cable 11 includes a data processing unit 21 (for example, in the vicinity of the interface 13), which measures and registers the electrical parameters and/or the communication parameters. In given cases, the cable 11 includes the measurement module and the registration module. The measured values are stored, for example, persistently, in the measurement transmitter 20. The measured values are then transferred from the measurement transmitter 20 to the testing tool 2 linked (subsequently) to the cable 11.

Claimed is:

1. A method for testing an inductive communication link between a cable and a sensor linkable thereto, comprising:
mechanically and electrically linking a device with the cable;
measuring at least one electrical parameter during communication or in a communication pause between the device and the cable;
registering at least one communication parameter during communication between the device and the cable;
creating communication statistics; and
persistently storing all measured values.

2. The method as claimed in claim 1, wherein the communication statistics include identifying a direction of a disturbance between the device and the cable.

3. The method as claimed in claim 1,
wherein the at least one electrical parameter is
transferred voltage,
transferred electrical current,
inductance(s),
capacitance(s),
impedance(s),
frequency,
phase between voltage and electrical current,
level of the modulated signal during the communication, and/or
total harmonic distortion.

4. The method as claimed in claim 1,
wherein the at least one communication parameter is
baud rate,
bit times,
character delay time,
frame time-out,
response time,
error rate,
signal-noise ratio,
latency,
jitter,
throughput,
pause between two telegrams, and/or
packet loss.

5. The method as claimed in claim 1,
wherein measuring the at least one electrical parameter occurs continuously such that real time data is provided for analyzing the linkage.

6. The method as claimed in claim 1,
wherein registered baud rates and bit times are used to optimize synchronization of data transfer.

7. The method as claimed in claim 1,
wherein communication statistics are used to detect patterns and anomalies in data transfer.

8. The method as claimed in claim 1,
wherein measuring the at least one electrical parameter occurs at different frequencies to analyze frequency dependence of the linkage.

9. The method as claimed in claim 1,
wherein measuring the at least one electrical parameter occurs under different load conditions to test loadability of the linkage.

10. The method as claimed in claim 1,
wherein the device is embodied as testing tool linkable to the cable,
wherein the inductive communication link between the cable and the testing tool is tested, and
wherein measured values are stored persistently in the testing tool.

11. The method as claimed in claim 1,
wherein the device is the sensor and the inductive communication link between the cable and the sensor is tested.

12. The method as claimed in claim 1,
wherein measured values are stored in a superordinated unit connected to the cable, or
wherein measured values are stored in a testing tool linked to the cable.

13. The method as claimed in claim 1,
wherein the method is initiated from a superordinated unit.

14. The method as claimed in claim 13,
wherein the superordinated unit is a measurement transmitter.

15. A testing tool, comprising:
an inductive interface for linking a complementarily embodied inductive interface of a cable;
a measurement module, embodied to measure electrical parameters;
a registration module, embodied to register communication parameters;
a data processing unit for performing the method as claimed in claim 1, wherein the data processing unit is embodied to analyze the registered values and to generate communication statistics; and
a persistent memory.
